(19) United States
(12) Patent Application Publication
(10) Pub. No.: US 2011/0052859 A1
(43) Pub. Date: Mar. 3, 2011

(54) PROCESSES FOR PRECUTTING LAMINATED FLOCKED ARTICLES

(75) Inventor: Louis Brown ABRAMS, Fort Collins, CO (US)

(73) Assignee: HIGH VOLTAGE GRAPHICS, INC., Fort Collins, CO (US)

(21) Appl. No.: 12/874,784

(22) Filed: Sep. 2, 2010

Related U.S. Application Data
(63) Continuation of application No. 11/849,840, filed on Sep. 4, 2007.
Application No. 11/849,840 is a continuation-in-part of application No. 10/961,821, filed on Oct. 7, 2004, now abandoned.
Application No. 11/849,840 is a continuation-in-part of application No. 09/735,721, filed on Dec. 13, 2000, now Pat. No. 7,364,782.
Application No. 09/735,721 is a continuation-in-part of application No. 09/621,830, filed on Jul. 24, 2000, now Pat. No. 7,344,769.
Application No. 11/849,840 is a continuation-in-part of application No. 09/621,830, filed on Jul. 24, 2000, now Pat. No. 7,344,769.
(60) Provisional application No. 60/509,834, filed on Oct. 8, 2003.

(51) Int. Cl. B32B 33/00

(52) U.S. Cl. 428/90

(57) ABSTRACT

A process for forming a flocked article is provided that includes the steps of: (a) cutting a pre-formed or solid adhesive film into a desired shape; (b) removing a first portion of the cut pre-formed adhesive film from a second portion of the cut pre-formed adhesive film; and (c) heating and applying pressure to the cut pre-formed adhesive film to adhere the film to flock to form a flocked article.

### CROSS REFERENCE TO RELATED APPLICATIONS

The present application is a continuation of U.S. patent application Ser. No. 11/849,840, filed Sep. 4, 2007, which is a continuation-in-part of U.S. patent applications having (a) Ser. No. 10/961,821, filed Oct. 7, 2004, which claims the benefits of U.S. Provisional Application Ser. No. 60/509,834, filed Oct. 8, 2003, entitled “Process for Forming Flocked Articles”; and (b) Ser. No. 09/735,721, filed Dec. 13, 2000, which is a continuation-in-part of U.S. application Ser. No. 09/621,830; and (c) Ser. No. 09/621,830, filed Jul. 24, 2000, each of which is incorporated herein by this reference.

### FIELD OF THE INVENTION

The present invention is directed generally to decorative articles and specifically to flocked articles.

### BACKGROUND

Flocked decorative articles are gaining in popularity. Flocking involves applying short monofilament fibers, usually nylon or rayon, directly onto a substrate that has been previously coated with an adhesive. The diameter of the individual flock strand is only a few thousandths of a centimeter and ranges in length from about 0.25 to about 5 mm. Decorative flocking is accompanied by using one of four application methods, electrostatic, beater bar/gravity, spraying, and transfers.

In one process configuration, a flock transfer, which includes a sacrificial carrier sheet adhered by a release adhesive to flock is laminated to a pre-formed adhesive film, such as a thermoplastic or thermoset film. The laminate is cut to provide the finished design.

When cutting is performed after lamination, it has been discovered that the final product can have flaws. In such applications, the final design image must be cut from the laminated film by cleanly cutting through the adhesive film layer, with the unwanted portion to be discarded being “weeded” out or peeled away for removal and discard. For very fine and delicate designs, such as a 12-point font lettering it is impractical at best, impossible at worst, to make cutting dies so other cutting methods like laser cutting are preferred.

In one type of laser cutter, the laser head does not move around to locate itself directly over the cut. Instead, the laser head is in a fixed position at the side of the cutting machine. From this position, the head projects the laser beam onto a mirror in the center of the cut area. The mirror is also fixed but swivels to focus the beam at the desired location. The farther the mirror is away from the center of the cut area; the more of an angle that the laser beam is working at. The challenge is to focus the laser precisely on the film layer, which becomes even more serious if the laser beam is cutting further away from the mirror. This results in a more extreme angle such that any inaccuracy in laser focus causes the laser to either not cut far enough into the film or cut too far and past the film, such as into the flock fiber layer. The long thickness of material cut is limited or angled by this type of laser cutter, which is the fastest type known.

Other problems with laser cutters include not only the inconsistency of the clean cut (e.g., little strings remain making removal of the part to be weeded out very difficult to do) but also jagged or wavy edges. While not wishing to be bound by any theory, it is believed that the inconsistency is the result of a slightly uneven fiber surface and/or the flowing of the adhesive film onto and into the flock fibers adjacent to the cut.

### SUMMARY OF THE INVENTION

These and other needs are addressed by the various embodiments and configurations of the present invention. The present invention is directed generally to pre-cut adhesive film(s) for flocked graphics, both by direct flocking and transfer flocking techniques.

In one embodiment, the present invention is directed to a process in which flock is laminated to an adhesive film to adhere permanently the adhesive to the flock. The adhesive film and/or a transfer comprising the flock are cut before lamination. The unwanted portions of the cut adhesive film and/or transfer are removed from the wanted portions before lamination is performed.

In one embodiment, the adhesive film includes an adhesive layer attached to a release sheet and the adhesive layer, and/or the release sheet, is cut through prior to lamination. The wanted portion of the adhesive layer remains on the release sheet while the unwanted portion is removed from the release sheet and discarded. A flocked release sheet is then contacted with the wanted portion, and the flock fibers are laminated to the wanted portion of the adhesive layer. Flock fibers adjacent to the portion(s) of the release sheet, from which unwanted portion(s) of the adhesive layer have already been removed, are removed, after lamination, with the flock carrier sheet.

The positioning of cutting and weeding operations before heating/activating (full or partial) of the adhesive film can have numerous benefits. By performing cutting before lamination, the transfer is cut before the transfer sheet is attached to the flock. By cutting on a relatively smooth, flat and fine gauge release sheet or the adhesive film itself, adjustment of the cutting device cut can be precise, much faster, and without influence from the fiber layer. The unwanted portion to be discarded can be peeled away easily and disposed of before lamination.

Another object of the present invention is to provide a stretchable transfer or design that prevents the flock fiber adhesive layer from becoming detached from the design or transfer, before, during and after the transfer or design is stretched.

Yet another object of the present invention is to provide a stretchable or elastic design that has shape memory and will reform, after being stretched, substantially to its original shape and size without loss of original design integrity.

Still yet another object of the present invention is to provide a stretchable or elastic design that, when stretched to a high degree, evidences an increase in the inter flock distance (i.e., the horizontal space between individual fibers) without the flock becoming disengaged from the substrate.

At least one embodiment of the present invention describes a flocked stretchable design and a process for producing a flocked stretchable design or transfer. The design can have shape memory even when stretched to a high degree.

In one embodiment, the design is configured as a transfer. The transfer includes a sacrificial carrier layer or release sheet, a release adhesive or binder applied to the carrier layer, a plurality of (preferably multi-colored) flock fibers releasably or temporarily attached to the release adhesive, an elastic (e.g., elastomeric) film, and a first (preferably continuously distributed) activatable adhesive layer (e.g., a thermoset or hot melt adhesive) permanently bonded to a first side of the elastic film. The plurality of flock fibers is permanently bonded to first side of elastic film by means of the first activatable adhesive layer. A second activatable, preferably discontinuously distributed, adhesive layer is bonded to an opposing, second side of the elastic film.

While not wishing to be bound by any theory, it is believed that the gaps or spaces (or discontinuities) in the second activatable adhesive layer assist the shape memory of the design. In the absence of the gaps or spaces, it is believed that, when the design is stretched, the continuously distributed second activatable adhesive layer will locate into voids in the adjacent, stretched flock layer, thereby preventing the design from returning to its original shape and size. The discontinuities in the second activatable adhesive layer not only provide expansion room for the adhesive when deformed but also prevent the adhesive from flowing into the deformation voids in the adjacent, stretched flock layer by reducing the total mass while still providing effective point-by-point adhesion. The discontinuities are preferably retained after the design is bonded to a suitable substrate. When the second discontinuous activatable adhesive is activated to bond the design to a desirable substrate, it is believed that the second discontinuous activatable adhesive layer soaks, flows, or “wicks” down into the substrate, vertically not laterally, on which the design or transfer is mounted maintaining the voids. This wicking allows the substrate and the design to stretch at the same rate and reform to their respective original shapes without permanent deformation of either the substrate and the design or the interface between them.

In another embodiment, the design is direct flocked and includes the elastic film, the first (preferably wet coated) activatable adhesive layer, a plurality of flock fibers, and the second activatable, discontinuously distributed, adhesive layer. As will be appreciated, the design of this embodiment does not include a transfer carrier layer and a release adhesive.

In other embodiments, the present invention also includes methods of producing both the design of both configurations.

The various embodiments of the present invention can have a number of advantages compared to conventional designs. For example, the design can combine the multi-colored plush design that is attainable with flocked fibers with high elasticity and shape memory. The flock fibers are stable and do not become detached from the design, before, during and after the transfer or design is stretched. The design quality of the design can be retained after any number of elastic deformations. The design can be applied to a variety of elastic substrates that have previously been unsuitable for flocked designs. Examples include highly elastic substrates such as Lycra®, elastomeric materials, such as rubber, and latex.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 shows a process configuration according to a first embodiment of the present invention;

FIG. 2 is a side view of contacted films in the process configuration of FIG. 1;

FIG. 3 is a side view of a flocked film in the process configuration of FIG. 1;

FIG. 4 is a side view of a product in the process configuration of FIG. 1;

FIG. 5 shows a process configuration according to a second embodiment of the present invention;

FIG. 6 is a plan view of a composite film in the process configuration of FIG. 5;

FIG. 7 is a plan view of a cut composite film in the process configuration of FIG. 5;

FIG. 8 is a side view of a film product in the process configuration of FIG. 5;

FIG. 9 shows a process configuration according to a third embodiment of the present invention;

FIG. 10 is a plan view of a cut adhesive film in the process configuration of FIG. 9;

FIG. 11 is a plan view of a flock transfer positioned on top of the cut adhesive film of FIG. 10;

FIG. 12 is a plan view of a laminated film product in the process configuration of FIG. 9;

FIG. 13 is a side view of a laminated film product in the process configuration of FIG. 9;

FIG. 14 shows a process configuration according to a fourth embodiment of the present invention;

FIG. 15 is a plan view of a cut and unweeded adhesive film in the process configuration of FIG. 14;

FIG. 16 is a plan view of a cut and weeded adhesive film in the process configuration of FIG. 14;

FIG. 17 is a side view of an adhesive film in the process configuration of FIG. 14;

FIG. 18 is a side view of a laminated film product in the process configuration of FIG. 14;

FIG. 19 is a side view of a flocked design in the process configuration of FIG. 14; and

FIG. 20 is a side view of a flocked release sheet in contact with a cut and weeded adhesive film.

FIG. 21 is a cross-sectional view of one embodiment of the invention as an design, using a direct flock method of flock application;

FIG. 22 is a cross-sectional view of one embodiment of the invention as a transfer, using a transfer method of flock application;

FIG. 23 is a cross-sectional view of one embodiment of the invention as an design mounted on a substrate;

FIG. 24 is a cross-section view of one embodiment of the present invention, having a dual first activatable adhesive layer;

FIG. 25 depicts a stretchable design, in a non-stretched position;

FIG. 26 depicts a stretchable design, in a fully stretched position; and

FIGS. 27 and 28 depict cross-sectional, detailed views of one embodiment of the present invention, showing the voids in detail.

### DETAILED DESCRIPTION

### Direct Flocking Process

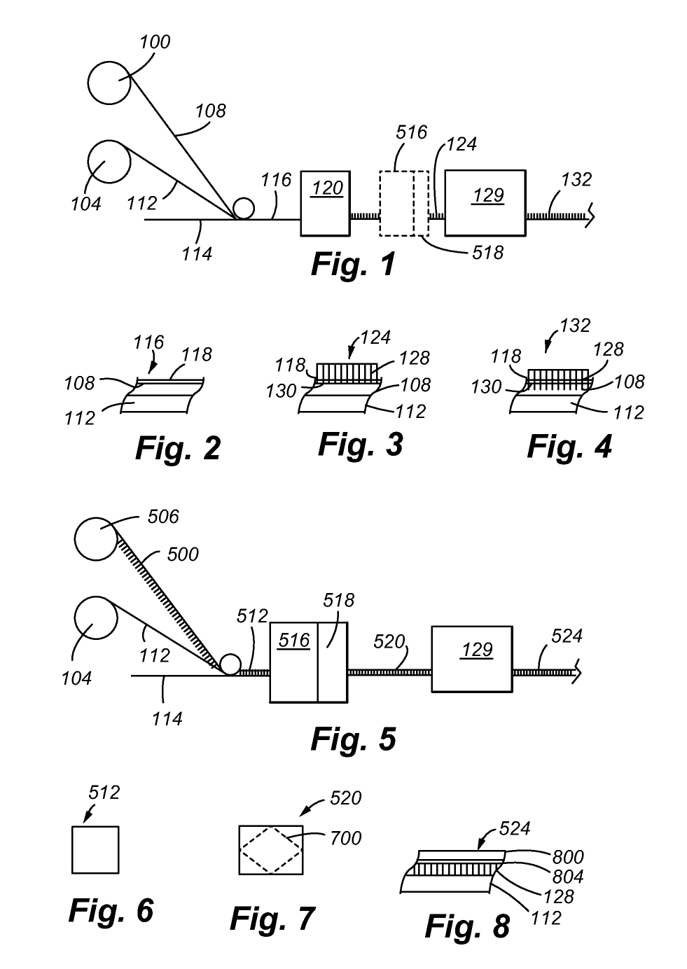

Referring to FIGS. 1-5, a system for manufacturing a flocked article according to a first embodiment of the present invention is depicted. The system includes a first roll 100 containing a permanent (pre-formed) adhesive film 108 and a second roll 104 containing a substrate film 112. The second roll 104 and substrate film 112 is omitted in certain applications. The pre-formed films 108 and/or 112 are contacted one on top of the other on a continuous running web line 114.

The adhesive film 108 can be any suitable adhesive film for the application. As will be appreciated, an “adhesive” is any substance, whether inorganic or organic, natural or synthetic, that is capable of bonding other substances together, typically by surface attachment. Examples of suitable adhesives include high temperature adhesives, such as polybenzimidazoles and silica-boric acid mixtures or cermets, hot-melt adhesives, thermoset adhesives, thermoplastic adhesives, and polyurethane. “Hot-melt adhesives” generally refer to a solid material that forms a mechanical or melt bond upon heating and subsequent cooling, “thermoset adhesives” generally refer to a polymer that solidifies or “sets” irreversibly when heated, and “thermoplastic” generally refer to a polymer that softens when heated and resolidifies when cooled to room temperature. The irreversible setting of the adhesive is effected by cross-linking of at least most, if not all, of the polymers in the adhesive. The adhesive film can include fine particles of polymers or copolymers, as well as one or more of plasticizer(s), stabilizer(s), curing agent(s) (such as an isocyanate), pigment(s), etc. The pigment, if any, determines the color and opacity of the adhesive film. The stabilizer, used when pigment is added, prevents discoloration of the resin film. Thermoset adhesives can include curing agents such as organic peroxides or sulfur. Examples of thermosetting adhesives include polyethylene, polyurethanes, polyamides, phenolics, alkyds, amino resins, polyesters, epoxides, and silicones.

The adhesive film 108 is preferably pre-formed before contact with the flock. As will be appreciated, pre-formed adhesive films can be formed by any number of processes, including solvent casting and extrusion. The adhesive film can be one or a combination of the above-types of adhesive layers. For example, the adhesive film may be a combination of two or more of thermoplastic, thermosetting, and/or pressure sensitive adhesive layers. In one configuration, the adhesive film includes only a thermosetting adhesive. In another configuration, the thermosetting adhesive useful for a sticker includes an approximately 1 mil thermosetting polyurethane liner with a pressure sensitive adhesive. The various layers are preferably adhered to one another, such as by laminating techniques, prior to cutting so that the cutting device is able to cut through all of the layers simultaneously.

The substrate film 112 can be any desired film, whether adhesive or nonadhesive. In a preferred configuration, the film 112 is a formable thermoplastic material having a softening point that is at or near the maximum temperature experienced by the substrate film 112 in later processing steps, such as molding. In molding, the maximum temperature is typically less than the melting point and maximum temperature of the resin to provide a melt bond and tensile and compressive strengths and thermal stability sufficient to withstand the maximum pressures experienced in the closed mold without warping or shrinking. The softening point of the substrate film is typically slightly lower than the maximum temperature realized by the resin and substrate film during molding. As will be appreciated, it is important that the resin be chemically and physically (e.g., thermally) compatible with the substrate film to produce a strong melt bond between materials and thus an integral article after removal from the closed mold. Preferably, the substrate film is a polymeric material and the polymers in the substrate film melt bond with the polymers in the resin. Exemplary backing films include monomers, oligomers, or polymers (which term includes copolymers, terpolymers, etc.) of styrene, acrylics, vinyls, olefins, cellulosics, carbonates, urethanes, amides, ethylenes, carbonates, propylenes, and esters, acrylic butyl styrene (ABS), and mixtures thereof. A particularly preferred substrate film for many resins is a polycarbonate. Thus, the film is able to withstand high pressure and high temperature without degrading, cracking, or melting. In another configuration, the substrate 112 is a carrier sheet with or without a release adhesive between the carrier sheet and adhesive film.

The substrate film is preferably nonwoven and neither a textile nor a fabric. Preferably, the substrate film, like the adhesive film, is in the form of a cast or extruded continuous film. Woven textiles and fabrics can resist stretching or form wrinkles when trying to form into a three-dimensional or nonplanar shape due to the weave of the material.

The contacted films 108 and 112 are subjected to flocking in a flocking device 120 to form a flocked film 124. The flock is held in position on the adhesive film by a binder adhesive 118. The flock fibers 128 can be formed from any natural or synthetic material. Synthetic material includes rayons, nylons, polyamides, polyesters such as terephthalate polymers and acrylic, and natural material includes cotton and wool. In one configuration, a conductive coating or finish is applied continuously or discontinuously over the exterior surface of the flock fibers to permit the flock fibers to hold or attract moisture (water content) and thus an electrical charge.

The conductively coated flock is applied by electrostatic flocking techniques such as described in U.S. Pat. Nos. 4,810,549; 5,207,851; 5,047,103; 5,346,746; 5,597,637; 5,858,156; 6,010,764; 6,083,332; and 6,110,560 and in copending U.S. patent application Ser. Nos. 09/548,839; 09/621,830; 09/629,746; and 09/735,721, each of which is incorporated herein by this reference. The flock is electrostatically charged (while the combined films 116 are given the opposite electrical charge or have neutral polarity by grounding).

Electrostatic flocking causes typically at least most, and even more typically at least about 65%, of the individual flock fibers to be oriented transverse to and typically perpendicular to the planes of the substrate surface (in direct flocking) Compared to woven textiles, this non-woven fiber alignment forms a desirable dense pile finish.

Preferably at least most, and even more preferably at least about 75%, and even more preferably all, of the flock fibers have a preferred denier of no more than about 60, more preferably no more than about 25, and even more preferably no more than about 5, with a range of from about 1.5 to about 3.5 being typical and have a titre ranging from about 0.5 to about 20 Dtex (from about 0.5 to about 20×10⁻⁷ Kg/m) and even more preferably from about 0.9 Dtex to about 6 Dtex. The length of at least most, and typically at least about 75%, of the fibers is preferably no more than about 4 mm, more preferably no more than about 2 mm, and even more preferably no more than about 1 mm, with a range of from about 0.3 to about 3.5 mm being typical. The fiber placement density relative to the surface area of the upper surface 1116 of the substrate (on which the flock is deposited) is preferably about 50% fibers/in², even more preferably at least about 60% fibers/in², and even more preferably at least about 70% fibers/in² of the surface area of the substrate surface 1116.

In these processes, different colors of flock (or fibers) are typically applied through separate screens or a single color flock is applied and later sublimation printed to form the multi-colored design. In multi-color flocking, the screens have a distribution of openings consistent with the desired locations of the respective colors of flock fibers. Other techniques, which can mount the flock in a desired position and in such a way as to hold or entrap the flock after curing, can also be employed in either the direct or transfer flocking process configurations. Such techniques include vibration, gravity, and spraying of the flock onto the adhesive-coated surface.

Cutting and weeding devices 516 and 518 are located between the flocking device 120 and heating and/or pressurizing device 129 in the process of FIG. 1. The cutting device 516 cuts the flocked surface 124 into desired shapes as discussed below while the weeding device 518 peels off or removes the unwanted portions of the flocked surface 124 before lamination. The cutting device can be a suitable cutting device, such as a steel-rule die, hard tool metal die, laser cutter, ultrasound cutter, high frequency cutter, or water jet cutter.

In one alternative embodiment, the films 108 and 112 are cut before flocking occurs. In other words, the cutting and weeding devices 516 and 518 are positioned between the rolls 100 and 104 and the flocking device 120 so that cutting and weeding occurs before the flock is in (intimate) contact with the film 108. This avoids problems from adhesive films flowing down the flock fibers and unevenly cut films (because of the uneven nature of a flocked coating). In this embodiment, a direct flock (second) adhesive could be applied, such as by spraying, to adhesive film 108 in register to the cut film pieces, possibly with an overlap around at least a portion of, and commonly all the way around, the cut adhesive film piece. Alternatively, the film 108 could be heated until it is sticky or tacky enough to adhere to the flock fibers and then direct flocked while held or maintained at temperature.

The flocked surface 124 is next treated by the heating and/or pressurizing device 129, such as a lamination machine, to produce a flocked product 132. The heating device heats the adhesive film 108 to a temperature above the softening point of the adhesive while the pressuring device applies pressure on the free ends of the flock fibers and forces the fibers into the softened adhesive film. As can be seen from FIG. 4, the flocked product 132 has the flock fibers 128 extending into the adhesive film 108 and passing through the upper surface 130 of the adhesive film 108. The softening and pressuring operations also cause the adhesive film 108 to adhere to the substrate film 112.

Preferably, the flocked surface is heated to a temperature below the melting point and full activation temperature of the adhesive film 108. In other words, the adhesive film 108 in the product 132 is typically not fully cross-linked. The adhesive film 108 is typically fully cross-linked in a later process step, particularly when the substrate film 112 is omitted. However, in certain applications, the adhesive film 108, during lamination, may be heated to a temperature to fully activate and cross-link the adhesive film.

### Transfer Flocking Process

The second embodiment of the present invention will now be discussed with reference to FIGS. 5-8.

As in the prior embodiment, the system includes first and second rolls 506 and 104. The first roll contains a flocked transfer sheet 500 and the second roll the adhesive film 112. The flocked transfer sheet 500 includes a release sheet 800 and release adhesive 804.

The release sheet 800 can be any suitable transfer carrier that is formable and dimensionally stable with the flock. Examples of other types of suitable transfer carriers include plastic films. The sheet is preferably a discontinuous sheet or a running web line material. The carrier sheet or film has been found to assist in robotically feeding the mold insert or mold insert film into the forming tool and/or the mold itself. A vacuum is able to pick up the mold insert or mold insert film and transport and position the insert at a desired location in the forming tool/open mold. Other techniques to establish a vacuum connection include (i) the use of a discontinuous release sheet, where the release sheet is positioned to contact the vacuum suction cups but not in other adjacent areas where flock is exposed due to an absence of an overlying release sheet, and (ii) the use of a discontinuously applied or located flock surface, where no flock fiber is deposited in first region(s) to provide an exposed permanent adhesive or backing film in the first region(s) to contact the suction cups from the flocked side of the insert. Flock is deposited in one or more adjacent second region(s) where no vacuum suction cup is positioned.

The release adhesive 804 is formulated such that the bonding force between the release adhesive 804 and the flock 128 is less than the bonding force between the adhesive 112 and flock 128. In this manner, the sheet and release adhesive can be removed after lamination of the transfer without causing separation of the flock from the adhesive film. Preferably, the melting point of the release adhesive is greater than the maximum temperature realized by the injected resin in the mold (and the melting point of the resin) and more preferably greater than the maximum temperature realized by the release adhesive during molding. As will be appreciated, for a cooled mold it is possible that the melting point of the release adhesive may be slightly less than the resin temperature.

The adhesive film and transfer 500 are contact one on top of the other to form a composite film 512. In the composite film 512, the adhesive film 112 is generally not adhered to bonded to the lower free ends of the flock 128.

The composite film 512 is subjected to cutting in a suitable cutting device 516. The film 512 (including both the transfer 500 and adhesive film 112) is cut into desired shapes, such as the diamond represented by cut lines 700 in FIG. 7. The cut takes place while the flock is still mounted on the release sheet. For laser cutting, the laser can be configured to cut to a precise depth or kiss cut so that it will not cut the web 114.

The cut film is next weeded by the weeding device 518. Unwanted portions, such as the film 512 portions located exteriorly of the diamond or cut lines 700, are removed prior to lamination. In other words, the diamond 700, but not the unwanted portions, remains on the web 114 for input into the heating and/or pressurizing device 129.

The cut and weeded composite film 520 is next heated and pressurized in the heating and/or pressurizing device 129 to form a film product 524.

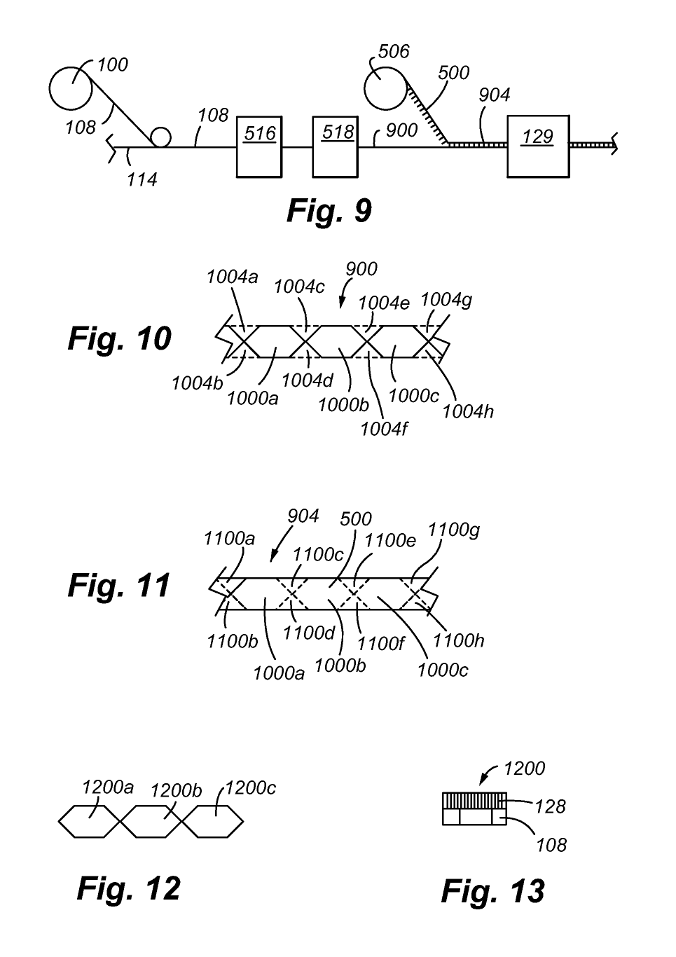

FIG. 9 depicts a process embodiment according to yet another embodiment of the present invention. The process includes a first roll 100 of the adhesive film 108, which is fed onto a continuous web 108. The adhesive film 116 is cut into desired shapes by the cutting device 516 and the unwanted portions removed from the web 114 by the weeding device 518.

FIG. 10 depicts the cut and weeded adhesive film 900. The cut and weeded film 900 includes a plurality of identically shaped repeating adhesive film segments 1000a-c. The adhesive film portions 1004a-h (the areas bounded by the dashed lines and peripheral lines of the film segments) positioned between the adjacent segments have been removed by the weeding device 518.

The cut and weeded film 900 is next contacted with the transfer 500 to form a composite film 904 before lamination occurs. FIG. 11 shows the transfer 500 positioned on top of the adhesive film segments 1000a-c (shown by dashed lines). As will be appreciated, the portions of the transfer 500 above the weeded out areas 1100a-h have no adhesive to adhere to. Thus, after lamination removal of the release sheet removes the flock in these areas as well (because the flock stays attached to the carrier sheet).

As can be seen in FIG. 11, the various adhesive film segments 1000a-c are interconnected by a thin part of continuous material peripherally running down the center of the material and the cut scrap material or weeded out areas 1100a-h may be interconnected by a thin part of continuous scrap material along at least one side of the portion of the cut material web to be discarded. In this way, a rewind mechanism can be used in the line (also called take-up reel) and when production begins the finished product and/or scrap material may be attached to the rewind wheel. The wheel or roll collects the material. In the case of weeding unwanted scrap material, the wheel or roll automatically removes the scrap material from the web before the scrap material is contacted with the flock fibers.

The laminator 1128 causes the adhesive film 900 to adhere to the overlying flock fibers in the transfer 500 to form a laminated film product 908. Removal of the release sheet produces a plurality of flocked articles 1200a-c shown in FIGS. 12 and 13. Each flock article 1200 includes a plurality of flock fibers 128 adhered to an underlying adhesive film 108.

The process of this embodiment is commonly preferred. The film combination can be quickly, precisely, and cleanly cut and weeded before being combined to flock-with-release-adhesive on another carrier substrate. During heat lamination and activation of thermoset films, for example, flock will only transfer where it is in contact with the precut thermoset film, and the peripheral flock fibers can do a nicer job of covering the edges than is possible with application of flock fibers before cutting of the adhesive film is performed. In the latter case, “raw” cut edges can be seen and sometimes have a white adhesive appearance visible from the side that looks unfinished and therefore of lower perceived value to consumers.

In another configuration, the transfer 500 can be precut and weeded using different cutting and weeding devices and located on top of the corresponding film segment 900 before lamination occurs. As will be appreciated, when a multicolor flocked design on the transfer 500 is being laminated to a pre-cut film it can be done in register. In other words, the cut film is aligned using known techniques with the corresponding flocked design.

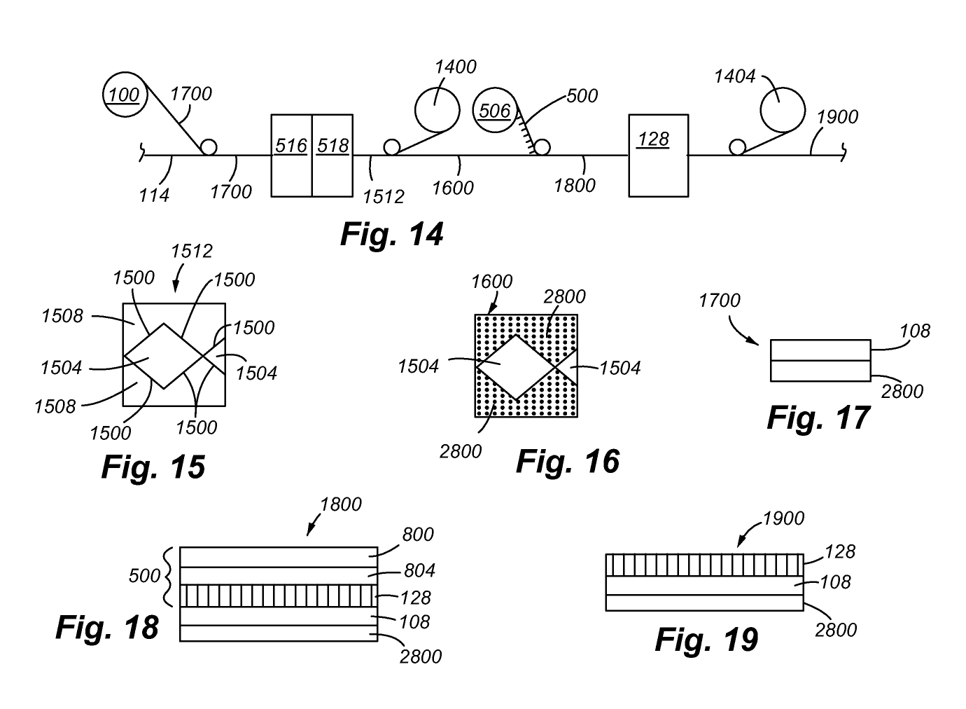

Another process embodiment will now be discussed with reference to FIGS. 14-18. The first roll 100 contains a permanent adhesive film 1700 shown in FIG. 17. The adhesive film 1700 includes a release or carrier sheet 2800 and the adhesive layer 108. The adhesive film 1700 is preferably self-supporting and formed by any suitable technique, such as lamination or solvent casting. In solvent casting, the liquefied adhesive is applied to the release sheet followed by curing to remove the solvent. This leaves the solidified adhesive supported by the release sheet. After the adhesive is applied to a desired surface, such as a free surface of the flock fibers 128, the release sheet 2800 is removed to expose the lower surface of the adhesive layer 108 for permanent attachment to a selected substrate.

The first roll 100 provides the adhesive film 1700 to the moving web 114.

The adhesive layer 108, while on the moving web and on the release sheet 2800, is cut to a desired shape by cutting device 516 to form a cut and unweeded adhesive film 1512. As noted, cutting device 516 is typically a die cutting device or laser cutter. FIG. 15 shows the cut lines 1500 in the adhesive layer 108. The cut lines 1500 define wanted and unwanted portions 1504 and 1508, respectively, of the adhesive layer 108. The cut lines 1500 typically pass through the adhesive layer 108 but not through the release sheet 2800.

In one configuration, the cut lines pass through the lower release sheet 2800. In this configuration, the unwanted adhesive portions 1504 and attached, cut release sheet 2800 fall automatically from the continuous web down onto a conveyer belt or directly into a bin, eliminating the need to hand-weed the unwanted portions from the wanted portions. This configuration is used for cutting devices, other than optical cutters such as lasers, that do not permit precise control of cut depth. Examples of such devices include mechanical cutters.

The weeding device 518 causes the unwanted portions 1504, which are interconnected on either side of the wanted portions 1504, to be separated from the wanted portions 1504 and collected on a third roll 1400. FIG. 16 shows the weeded adhesive film 1600. In the weeded adhesive film 1600, the wanted portions 1504 remain attached to the release sheet 2800 after removal of the unwanted portions 1508. The release sheet 2800 is exposed in respective areas by removal of the unwanted portions 1508.

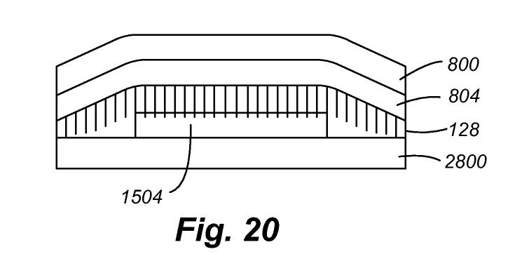

A second roll 506 provides a flocked release sheet 500. The flocked release sheet includes flock fibers 128 attached to a release or carrier sheet 800 by a release adhesive 804. The release sheet 800 is preferably a microporous film. FIG. 18 shows the assembly 1800. The assembly 1800 includes the upper and lower release sheets 800, 2800 release adhesive 804, flock fibers 128, and wanted portion(s) of the adhesive layer 108. Where the unwanted portions have been removed, the flock fibers 128 are not in contact with the adhesive layer 108 and, as shown in FIG. 20, instead may be in direct contact with the release sheet 2800.

The assembly 1800 then passes through the lamination device 1128, which applies heat and pressure to cause the flock to adhere to and/or cure the remaining adhesive layer 108. Where the unwanted portions of the adhesive layer have been removed, the flock will not adhere to the adhesive layer and attached lower release sheet 2800.

The fourth rewind roll 1404 collects the upper release sheet 800, release adhesive 804, and unattached flock fibers 128. The unattached flock fibers 128 refer to the flock fibers that did not adhere to the wanted portion(s) of the adhesive layer 108, or that are located where the unwanted portion(s) have been removed. As can be seen in FIG. 19, the flocked design 1900 includes flock fibers 128 embedded in and adhered to the wanted portion of the adhesive layer 108, which is in turn adhered to the lower release sheet 2800. The shape of the wanted portions of the adhesive layer 108 is in the final desired shape for the design. To attach the design 1900 to a desired substrate, the lower release sheet 2800 is removed and the exposed surface of the adhesive layer 108 attached, is applied under heat and pressure, to the desired substrate (not shown). The desired substrate can be, for example, a textile or substrate film 112.

In one implementation, the fourth rewind roll 1404 collects only the release sheet 800 and attached release adhesive 804, leaving the flock 128, adhesive film 1504, and release sheet 2800 on the moving web. A further cutting step is performed, typically completely through the carrier sheet 2800, to the flock, film, and sheet to form features of a desired graphical design. For example, certain designs have disconnected design elements, like the letters in “FORD”. The letter outlines and/or only interior void spaces of the letters are cut by the second cutting device. Typically, the letter outlines are cut in the pre-cutting step and the interiors of the letters in the second or post-lamination cutting step. A second release sheet and release adhesive are then contacted with the flock fibers. The unwanted flock 128, adhesive film 1504, and release sheet 2800 segments are then adhered to the release sheet. The second release sheet is then collected on a further rewind roll (not shown) to remove and weed automatically the unwanted flock 128, adhesive film 1504, and release sheet 2800 segments.

The techniques of the present invention can be used in any process for manufacturing decorative objects. For example, the techniques can be used in the manufacture of heat transfers, direct flocked articles, molded flocked articles, and the like, such as disclosed in the following patents/patent applications: U.S. Provisional Application Ser. Nos. 60/422,206, filed Oct. 29, 2002; 60/393,362, filed Jul. 3, 2002; 60/416,098, filed Oct. 4, 2002; 60/403,992, filed Aug. 16, 2002; 60/405,473, filed Aug. 23, 2002; 60/366,580, filed Mar. 21, 2002; 60/327,642, filed Oct. 5, 2001, 60/344,862, filed Nov. 8, 2001, and 60/332,647, filed Nov. 21, 2001; and 60/393,362, filed Jul. 3, 2002; U.S. Pat. Nos. 4,810,549; 5,047,103; 5,207,851; 5,346,746; 5,597,637; 5,858,156; 6,010,764; 6,083,332; 6,110,560; U.S. patent application Ser. Nos. 10/265,206, filed Oct. 5, 2002; 09/629,746, filed Jul. 31, 2000; 09/735,721 filed Dec. 13, 2000; 09/621,830 filed Jul. 24, 2000; 29/058,551 filed Aug. 19, 1996; 09/548,839 filed Apr. 13, 2000; and 09/973,113 filed Oct. 9, 2001, each of which is incorporated herein by this reference.

In the embodiment of FIGS. 9-10, the release adhesive 804 can be selectively applied to the release sheet 800 only in locations where flock is needed (such as in the areas of the transfer 500 in contact with the adhesive segments 1000a-c), leaving the rest of the release sheet 800 blank or free of release adhesive (such as in the areas of the transfer 500 adjacent to the weeded our areas 1100a-c). In this manner, the flock will be applied only to the sections of the release sheet 800 contacting the release adhesive 804 with no flock being located in the sections of the release sheet 800 which are free of the release adhesive 804. The flock is thus applied only where needed, thereby saving material. As will be appreciated, the release adhesive is generally applied to those sections of the release sheet 800 overlying the adhesive film segments 1000a-c. In one configuration, the release adhesive is applied not only over the area of the release sheet 800 in contact with the adhesive film segments 1000a-c but also outside this area to avoid quality problems resulting from misregistration of the flocked area of the release sheet and the adhesive film segment.

In another embodiment, the performing of cutting before laminating is done in a process in which (a) a hotmelt film is contacted with a carrier, (b) the film is coated with adhesive and flock to form a flocked article, and finally (c) the flocked article cold laminated to a pressure sensitive adhesive to form a “sticker” on a carrier. Cutting is performed after step (a) and before steps (b) and (c).

A number of variations and modifications of the invention can be used. It would be possible to provide for some features of the invention without providing others.

For example in one alternative embodiment, the process of the second embodiment is not limited to transfers. As will be appreciated, instead of a transfer 500 the process may be used with direct flocking. In that event and with reference to FIG. 1, the laser cutting device 516 is positioned between the flocking device 120 and the heating/pressurizing device 1128.

In another alternative embodiment, the positions of the first roll 506 and the second roll 104 are reversed such that the release sheet 800 is positioned on the bottom (in contact with the running web line 114) and the adhesive film 104 on top. In other words, the film 512 is flipped upside down relative to the position depicted in FIGS. 5-8. The positioning of the release sheet 800 on the bottom can provide cleaner cuts and prevent cutting of the web line 114 by the cutting device 516.

In yet another embodiment, the laminating station can be any suitable device or devices for heating and softening the adhesive film and embedding the flock fibers in the film. In one configuration, the station is a clam shell-type device, for example.

In yet another embodiment, the cutting station is a device other than an optical (laser) cutter. It can, for example, be a mechanical cutter, such as a kiss cutter, a saw or knife blade, and the like.

Another embodiment of the present invention comprises a stretchable design or transfer and a method for making a stretchable design or transfer. The description which follows describes a preferred embodiment of the invention, and various alternative embodiments. It should be readily apparent to those skilled in the art, however, that various other alternative embodiments may be accomplished without departing from the spirit or scope of the invention.

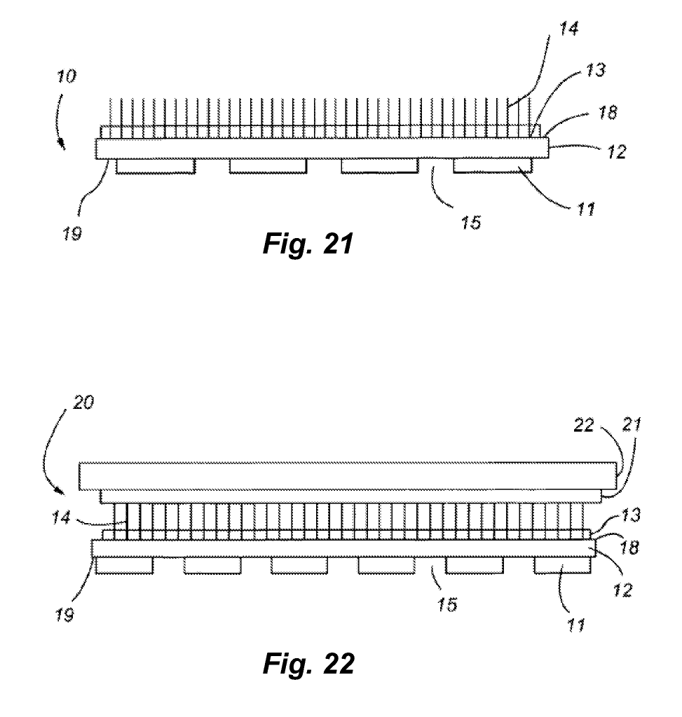

As shown in FIG. 21, a direct flocked design according to one embodiment of the present invention is shown. The design 10 has an elastic film 12, a first activatable (continuously distributed) adhesive layer 13 bonded to one side of the elastic film, a second activatable, discontinuously distributed, adhesive layer 11 that is applied to the other side of the elastic film, and a plurality of flock fibers 14 that are flocked onto the first activatable adhesive layer.

The elastic film should be durable, thermally stable, and able to resist the various treatments including but not limited to flocking, applying chemicals, washing, heating, drying, both during the flocking process and after the design or transfer has been applied to the article. The term “elastic” as used herein means those materials that have the ability to regain, at least substantially, their original shape after a load is removed. The elastic film preferably has a modulus of elasticity of less then 11.25 pounds per foot (“lbf”) (50 N). The modulus of elasticity for the material selected is preferably above 0.5 lbf (2.22 N) (where the modulus is defined as the force required to pull a ¼ inch sample from 3 inches to 6 inches). As the modulus of elasticity (Young's Modulus) is a fundamental material constant, the modulus is an index of the stiffness of the material. A higher value of the modulus indicates a more brittle material (i.e. glass, ceramics). A very low value represents a ductile material (i.e. rubber).

The elastic material can be of any suitable composition, such as rubber, polyurethane, and elastomers. Particularly preferred elastic materials include natural vulcanized rubber and elastomers, such as styrene-butadiene copolymer, polychloroprene (neoprene), nitrile rubber, butyl rubber, polysulfide rubber (Thiokol), cis-1,4-polyisoprene, ethylene-propylene terpolymers (EPDM rubber), silicone rubber, and polyurethane rubber. As will be appreciated, “elastomers” refer to synthetic thermosetting (typically high) polymers having properties similar to those of vulcanized natural rubber, namely the ability to be stretched to at least twice their original length and to retract quickly to approximately their original length when released. It has been found that a material with the trade name Clarense® from Bemis works well with at least one embodiment of the present invention.

The elastic film preferably has a thickness ranging from about 1 mil to 25 mils and more preferably, from about 1 mil to 15 mils.

The first activatable adhesive layer 13 is applied to the elastic film 12. The first activatable adhesive layer is preferably distributed continuously over the first surface 18 of the elastic film. The first activatable adhesive preferably has a thickness ranging from about 1 mil to 10 mils and more preferably from about 1 mil to about 3 mils. The first activatable adhesive layer provides a permanent grip of the flock fibers. The first activatable adhesive layer can be applied to the elastic film in any number of ways, e.g., applied as a liquid using suitable techniques or as a pre-formed film and both can be applied to the flock fibers simultaneously. Suitable adhesives for the first activatable adhesive are described in detail below.

The plurality of flock fibers 14 are flocked onto the first activatable adhesive layer through general and conventional flocking methods and techniques. The flock can be of multiple colors, which can be arranged in a pre-selected design, or can be of a single color. The flock 14 used in any of the processes discussed herein can be any electrostatically chargeable fiber, such as fibers made from rayon, nylon, cotton, acrylic, and polyester. Preferably, the flock has a melting and/or softening point that is greater than the temperatures experienced by the flock during activation of the first and second adhesives. Due to its low melt point, acrylic flock is undesirable in many applications. The flock is also preferably resilient under the temperatures and pressures experienced in design manufacturing and later application processes. Resilient flock, such as rayon and nylon flock, is particularly preferred. In most applications, the flock orientation is at least substantially orthogonal (perpendicular) to the first side of the elastic film.

In accordance with another embodiment of the present invention, in order to achieve a multicolor and/or textured effect, the flock 14 is applied through the image screen which is preferably a gauze-like mesh screen made of polyester monofilament material or by inkjet printing or sublimation transfer before the first and second activatable adhesive layers and elastic film are applied to the flock. The multicolor effect is achieved by using different precolored flock. A textured effect is achieved by using flock fibers of different length wherein flock fibers of substantially the same or uniform length are passed in batches through the open section of the barrier. As used herein, precolored flock means that the flock has been colored before being flocked, adhered stuck or otherwise applied to the release adhesive. Depending on the overall design texture and the color or number of colors of flock which are to be used, an appropriate number of barriers or screens are prepared to have open sections to permit passage of flock in a predetermined configuration, texture pattern, and/or color pattern. Alternatively, a single screen may be sequentially masked for this purpose. In either case, the open sections of each mask or screen are designed to permit passage of flock fibers in a configuration which corresponds to areas of the final design including any surrounding bleed areas which correspond to only one color and/or flock length, which is preferably one of a plurality of colors and/or fiber lengths of a color and/or texture pattern, intended to be used in the final or overall design. The screen also serves to mask areas which are not intended to receive a particular color or texture. In accordance with another embodiment of the present invention, each different color and/or different length of flock is preferably applied sequentially using a different screen to result in the particular precolored flock and/or flock of predetermined length passing through the open section of the screen onto a corresponding section of the release adhesive 21 to form a color and/or texture pattern.

Another embodiment of the present invention generally utilizes the general materials and flocking techniques found in U.S. Pat. Nos. 3,793,050; 4,292,100; and 4,396,662 and UK patent application Nos. 2,065,031 and 2,126,951 all of which are incorporated by reference herein. Another embodiment of the present invention can also utilize flocking materials and techniques such as those described in U.S. Pat. Nos. 4,810,549; 5,047,103; 5,207,851; 5,346,746; 5,597,637; 5,858,156; 6,010,764; 6,083,332; and 6,110,560 as well as copending patent applications U.S. application Ser. Nos. 29/058,551 filed Aug. 19, 1996; 09/548,839 filed Apr. 13, 2000; 09/621, 830 filed Jul. 24, 2000; 09/735,721 filed Dec. 13, 2000; 09/629,746 filed Jul. 31, 2000; 09/973,113 filed Oct. 9, 2001; 60/327,642 filed Oct. 5, 2001; 60/344,863 filed Nov. 8, 2001; 60/366,580 filed Mar. 21, 2002; 60/332/,647 filed Nov. 21, 2001 and 60/393,362 filed Jul. 3, 2002, of which I am an inventor. These patents and patent applications are also incorporated herein as if set forth in their entireties.

Returning again to FIG. 21, the second activatable, discontinuously distributed, adhesive layer 11 is applied to the second side 19 of the elastic film 12 and is not adjacent to the first activatable adhesive layer 13. The thickness of the second activatable, discontinuously distributed, adhesive layer preferably ranges from about 1 mil to 25 mils and more preferably from about 2 mils to 10 mils and even more preferably from about 2 mils to 5 mils.

The term “discontinuous” means that the adhesive, when applied to the elastic film, does not coat the entirety of the film but allows for holes or voids, shown in FIGS. 21 through 24 as voids 15, between areas of the adhesive. The voids allows the transfer or design to recover its original shape after stretching without deforming the substrate material on which the transfer or design is bonded. As will be appreciated, the discontinuous nature of the second activatable adhesive can be present before the application of the adhesive, such as a pre-formed film adhesive with holes, can be formed during application of the adhesive, or formed after application of the adhesive by removing selected portions of the adhesive (such as by using a mask).

Any suitable adhesive can be used for the first and second activatable adhesives. The first and second activatable adhesives typically have differing compositions. As will be appreciated, suitable adhesives fall into two general categories, namely organic and inorganic adhesives, with organic adhesives being preferred. Although either natural organic or synthetic adhesives are suitable, synthetic adhesives are preferred. Synthetic adhesives include elastomer-solvent cements, thermoplastic resins (for hot-melts) (e.g., polyethylene, isobutylene, polyamides, and polyvinyl acetate), thermosetting resins (e.g., epoxy, phenoformaldehyde, polyvinyl butryal, and cyanoacrylates), and silicone polymers and cements. Of the synthetic adhesives, thermoplastic (hot melt) resins and thermosetting resins are preferred. Thermoset adhesives solidify or set irreversibly when heated above a certain temperature. This property is usually associated with a cross-linking reaction of the molecular constituents induced by heat or radiation.

Suitable thermoset adhesives can include curing agents or catalysts such as organic peroxides, sulfur, oxalic acids, or diammonium phosphate. Thermosetting resins such as methylol-melamines, urea formaldehyde condensates or phenol formaldehyde condensates may be incorporated to improve durability or abrasion resistance of the design. Suitable examples of thermosetting adhesives include polyethylene, phenolics, alkyds, amino resins, polyesters, epoxides, and silicones. For use with another embodiment of the present invention a polyester, a polyurethane, or a polyolefin second activatable, discontinuously distributed, adhesive layer is preferred.

The adhesive can have any form, namely be in the form of a liquid, solid (such as a pre-formed film), or a gas (which is condensed onto the desired surface). As will be appreciated, liquid adhesives include without limitation, water-based, solvent based, or curable liquid systems. Water-based adhesives generally consist of a binder, usually an emulsion polymer, and a viscosity builder. Water-based adhesives may also contain plasticizers, thermosetting resins, curing catalysts, stabilizers and various other additives known in the art. The emulsion polymer is generally chosen from acrylic, vinyl-acrylic, vinyl, urethane, and styrene-butadiene latexes. The viscosity is dictated by the substrate and the specific adhesive. Suitable viscosity builders are typically water soluble polymers such as such as carboxymethyl cellulose, hydroxyethyl cellulose, polyoxyethylenes and natural gums as well as alkyl swellable polymers, such as, highly carboxylated acrylic emulsion polymers.

Plasticizers may be added to alter the properties of the design or to improve the flow and levelling characteristics of the adhesive. Where the primary goal is the latter, fugitive plasticizers, such as, the phthalate esters may be employed. If the intent is to alter the properties of the finished goods, then more permanent plasticizers such as low molecular weight polyesters may be used.

Solvent adhesives include those fully reacted soluble polymers, such as, acrylic homo and copolymers, polyesters, polyamides or polyurethanes and two package systems, such as, polyester polyols with diisocyanates, or isocyanate prepolymers and epoxies with polyamines. The polymer or prepolymer is dissolved in a suitable solvent which is preferably low boiling, and then thickened to the proper viscosity in a manner similar to that used for the water-base adhesives. Catalysts, cross-linking agents, stabilizers, pigments, or dyes may also be incorporated.

Curable liquid systems include 2 part urethanes, e.g., a diisocyanate and a polymeric polyol, flexible epoxy systems, e.g., liquid epoxy resins or solutions of solid epoxy resins co-reacted with polyamides or polyamines and dimercaptans and a polyene with a peroxide. Also, hot melts can be used, such as polyethylene-vinylacetate copolymer, polyethylene-ethylacrylate copolymer, and a plasticized polyvinyl chloride in the form of a plastisol which can be heated to fuse and then cure.

In one design configuration, the first activatable adhesive is preferably a thermoset adhesive while the second activatable adhesive is preferably a hot melt adhesive. The preferred adhesive for the first activatable adhesive is a polyester film by Bemis. To provide the desired discontinuities 15, preferred, pre-formed adhesive films for the second activatable adhesive include web adhesives such as the Sharnet® adhesive from Bostik-Findley. Sharnet® is a high performance adhesive produced in a nonwoven fabric foam. Web adhesives, such as the Sharnet® adhesive, can be applied through either a manual or automatic process to accommodate both application to individual articles and continuous line feed operations.

To produce the design 10 through a direct flock method according to another embodiment of the present invention and with reference to FIG. 21, an elastic film 12 is provided. The first side 18 elastic film 12 is coated with a first activatable (liquid) adhesive film 13. The plurality of flock fibers 14 is directly deposited, in the desired pattern, onto and in the first activatable film 13. The first activatable adhesive layer can then be dried and cured (fully activated). The second activatable, discontinuously distributed, adhesive layer is applied to the elastic film on the second side 19 opposite that of the flock. The second activatable adhesive is then dried and cured (partially activated). The flock can be vacuumed at any time after the flock is applied in order to remove any excess or loose flock fibers. As will be appreciated, the first and second activatable adhesive layers can be applied to the elastic film in any order.

FIG. 22 shows the design in the form of a transfer. The transfer 20 includes the elements of the design 10 described above and additionally includes a carrier film 22 and a release adhesive 21. The carrier film can be any type of material which is suitable for use on a temporary basis and which is relatively inexpensive inasmuch as it usually is only used once and disposed. Typically, carrier films can include but are not limited to paper, plastic, fabric, metallic foil and the like. Other carrier films, such as a backdrop or backcloth, which are suitable for reuse may also be used with at least one embodiment of the present invention. The carrier film should, however, be able to withstand the various flocking, coating and other treatments to which it will be subjected.

The release adhesive 21 is applied to the carrier film to bind the flock fibers in a certain orientation before the flock fibers are collectively bonded by the first activatable adhesive layer. The release adhesive is a composition which when subjected the usual curing conditions, e.g., heat, ultra-violet, etc., will not permanently set or permanently adhere to the substrate or to the flock. Such compositions typically include but are not limited to waxes, low molecular weight polyethylenes, polystyrenes, and the like. Additionally, starched-based adhesives such as, canary dextron and British Gum; gums, such as gum arabic and gum tragacanth; water soluble, non-curing polymers, such polyvinyl alcohols, particularly hydrolyzed polyvinyl acetate and the like may be used. Another example of appropriate composition is glycerine and urea.

To produce a transfer according to another embodiment of the present invention and with reference to FIG. 22, a carrier film 22 is provided and a release adhesive 21 is applied to the carrier film. The release adhesive can be applied to the carrier layer in any manner, including by means of a knife or with roll, stipple roller, spray or other methods including but not limited to those methods described in U.S. Pat. Nos. 4,810,549; 5,047,103; 5,207,851; 5,346,746; 5,597,637; 5,858,156; 6,010,764; 6,083,332; and 6,110,560, of which I am an inventor. These patents are incorporated herein as if set forth in their entireties. After application of the release adhesive to the carrier layer, one end of the plurality of flock fibers 14, in the reverse of the desired pattern, is then deposited onto and in the release adhesive 21 and dried. The dried plurality of flock fibers can now be vacuumed to remove excess or loose fibers. The free or exposed ends of the plurality of flock fibers (i.e., the ends which are not attached to the release adhesive) are coated with the first activatable adhesive layer. At the same time, the first activatable adhesive layer is contacted with the first side 18 of the elastic film. The first activatable adhesive layer is then dried and fully activated or cured. The second activatable adhesive layer is then applied to the second side 19 of the elastic film. The second activatable adhesive layer can then be dried and partially activated for later application to a suitable substrate. It should be noted that with either the direct flock or transfer methods, the process can be performed as a continuous line operation or can be performed in separate stages. In one process configuration, the first and second activatable adhesive layers, elastic film, and flocked release sheet are laminated simultaneously.

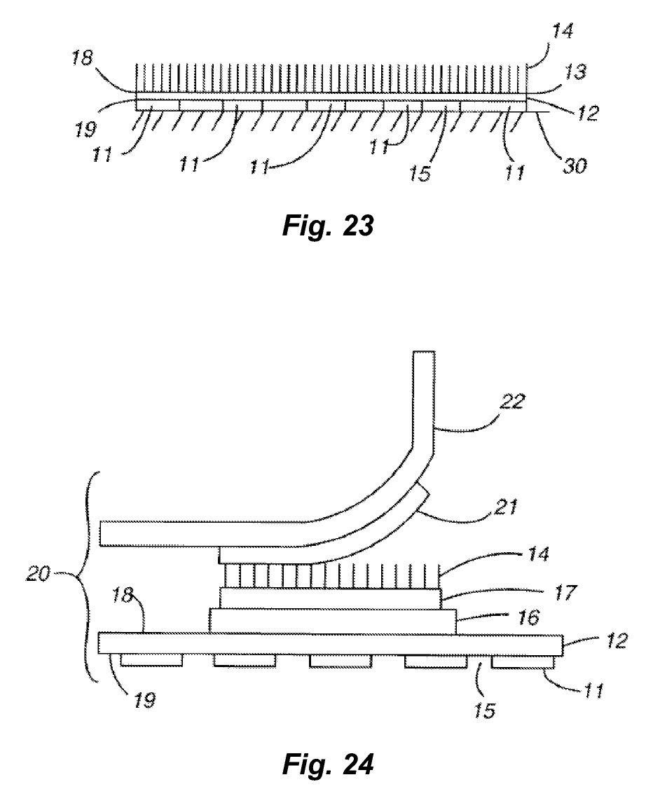

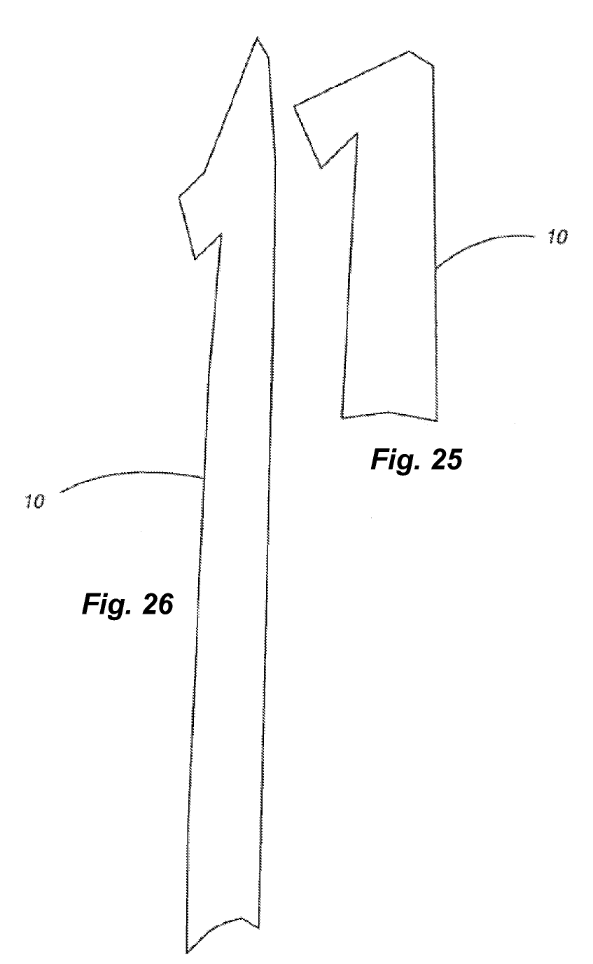

FIG. 23 also shows a substrate 30 on which the design, transfer or patch will be mounted. The substrate can be any material to which it is desired to attach the transfer, design or sew on patch. The substrate can also be an elastic/elastomeric material, such as Lycra and like materials; however, the stretchable transfer or design of at least one embodiment of the present invention can also be used in conjunction with molded articles. Preferably, the substrate has a same or similar modulus of elasticity as the elastic film of the transfer or design. This allows the substrate and the transfer or design to stretch at similar rates. Even more preferably, the design has an elasticity that is substantially the same as or greater than the elasticity of the substrate. Preferably, the amount of stretch of the design and substrate is at least 20% of their original sizes.

FIG. 24 shows a dual layer thermoset arrangement which falls within the scope of another embodiment of the present invention. The dual layer thermoset arrangement comprises a hot melt layer 16 and a binder adhesive layer 17 in place of the first activatable adhesive layer 13 discussed above. It should be understood that another embodiment of the present invention encompasses a layer where the binder adhesive and the hot melt form only one layer. The flock 14 is coated with a binder adhesive 17, such as a water based acrylic, which binds the flock into a unit and is a barrier for the hot melt. Preferably the binding adhesive is applied in the form of a solution or emulsion. The binder adhesive preferably contains a resin, such as polyvinyl chloride, polyvinyl acetate, polyurethane, polyester, polyamide, and acrylic resin, and preferably the previously mentioned water based acrylic. A preferred binder adhesive is commercially available as Tubitrans Bond manufactured by Chemische Fabrik Tubitrans R. Beitlich GmbH & Co. Turbitrans Bond is an acrylic dispersion which is cross-linkable at higher temperatures in the form of a high viscosity, white paste. The acrylic dispersion has a viscosity of cp. 4.5-4.6 measured with Contraves Viscometer, type Eppprecht, Instrument and a pH of about 7-8. This acrylic resin dispersion may be mixed with Tubitrans Fix 2 and optionally further with a colormatch dyestuff. A preferred release adhesive, therefore, would be 100 parts Tubitrans Bond, 8 parts Tubitrans Fix 2, and 0-3 parts colormatch dyestuff. The binder adhesive 17 may contain additional or supplemental adhesives, such as a hot melt adhesive, usually a granular polyester or nylon, for binding the transfer to a substrate.

The hot melt adhesive 16 is then applied to the binder 17 as a separate layer. In addition, other heat sensitive adhesives, such as polyvinyl chloride, thermoplastic acrylic resin, polyethylene, polyamide, polyurethane, paraffin and rubber derivative may be used for this purpose, with polyurethane being preferred.

In one alternative embodiment, the elastic film 12 can be used as the film backing of a co-molded direct flock and flock transfer such as that described in U.S. Patent Application Ser. No. 60/393,362, filed Jul. 3, 2002, or in place of the barrier layer 204 described in FIG. 9 of the same application. This patent application is incorporated herein as if fully set forth.

In another alternative embodiment, the elastic film 12 and second activatable adhesive layer 11 can also be used as an optional layer in the screen printed resin film design or transfer made from a liquid plastic dispersion such as that described in U.S. Patent Application Ser. Nos. 60/332,647, filed Nov. 21, 2001; 60/344,862 filed Nov. 8, 2001; and 60/327,642, filed Oct. 5, 2001. The entireties of these patent applications are incorporated herein as fully set forth.

In yet another alternative embodiment, the design is configured as a sew-on patch. When so configured, the second activatable adhesive layer can be eliminated or can be used sparingly to provide additional bonding capabilities.

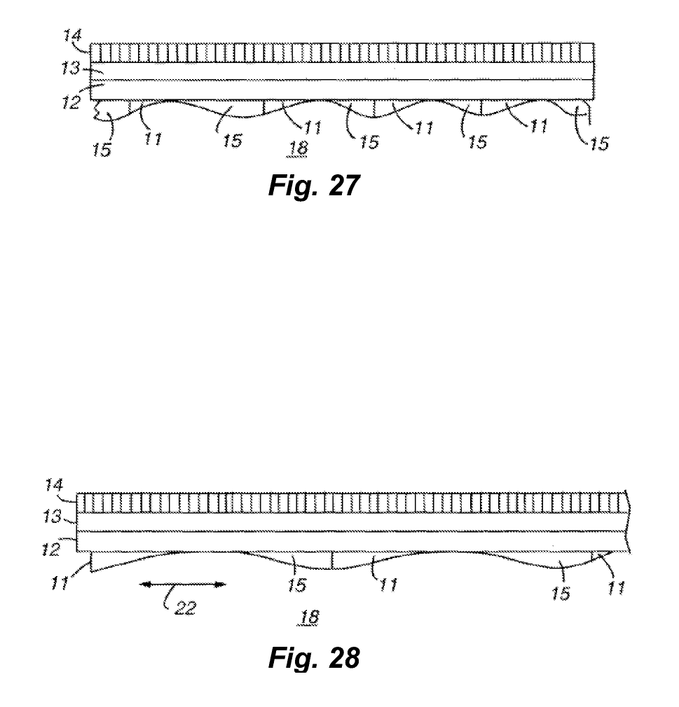

As one can observe from FIGS. 27 and 28, in one embodiment of the invention, the flock fibers 14 are embedded in the first activatable adhesive layer 13 and the elastic film 12. The second activatable adhesive layer 11, shown in a discontinuous form, bonds to the elastic film 12 and woven textile 18 and also creates voids 15. While not wishing to be bound by any theory, it is believed that, when the textile 18 is stretched along line 22, the design breaks along dashed lines 26 a, b, and c producing visible gaps 30 a-b between the flock fibers. However, when released, the design resumes its original design without visible gaps in the flock fibers. It is believed that this phenomenon keeps the flock fibers embedded in the first activatable adhesive layer and the elastic film in a vertical orientation while allowing the interflock fiber distance (i.e., the horizontal distance between two individual flock fibers) to increase.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1-20. (canceled)

21. A flocked article, comprising: a plurality of flock fibers; an elastic film having first and second sides, the elastic film comprising rubber and/or an elastomer; a first adhesive layer bonded to the first side of the elastic film and to the plurality of flock fibers, the first adhesive layer being substantially continuously distributed over the first side of the elastic film; and a second adhesive layer bonded to the second side of the elastic film, the second adhesive layer being substantially continuously distributed over the second side of the elastic film.

22. The article of claim 21, wherein the first and second adhesive layers are thermoplastic.

23. The article of claim 22, wherein the first adhesive comprises one of polyethylene, isobutylene, polyamide, polyvinyl acetate, acrylic, vinyl-acrylic, vinyl, urethane, styrene-butadiene latexes, polyethylene-vinylacetate copolymer, polyethylene-ethylacrylate copolymer, polyester, polyvinyl chloride, polyurethane, polyester, acrylic resin, polyvinyl chloride, thermoplastic acrylic resin, polyethylene, paraffin and rubber derivative and wherein the second adhesive comprises one of polyethylene, isobutylene, polyamide, polyvinyl acetate, acrylic, vinyl-acrylic, vinyl, urethane, styrene-butadiene latexes, polyethylene-vinylacetate copolymer, polyethylene-ethylacrylate copolymer, polyester, polyvinyl chloride, polyurethane, polyester, acrylic resin, polyvinyl chloride, thermoplastic acrylic resin, polyethylene, paraffin and rubber derivative.

24. The article of claim 21, wherein the one of the first or second adhesives comprises a thermoplastic adhesive and the other of the first and second adhesives comprises a thermosetting adhesive.

25. The article of claim 21, further comprising: a carrier; and a release adhesive deposited upon the carrier, wherein the plurality of flock fibers is releasably attached to the release adhesive.

26. The article of claim 21, wherein the elastic film has a modulus of elasticity of less than about 11.25 lb/ft and more than about 0.5 lb/ft.

27. The article of claim 21, wherein the elastic film has an elongation of at least about 200%.

28. The article of claim 21, wherein the elastic film is a thermosetting elastomer and has a recovery of at least about 75% after being stretched to 100% of the film's length and allowed to retract freely.

29. The article of claim 21, wherein the elastic film is at least one of a rubber, styrene-butadiene copolymer, neoprene, polyisoprene, polyester, polyamide, polypropylene, polyethylene, and polyurethane.

30. The article of claim 21, wherein the elastic film is a thermoplastic polyurethane.

31. The article of claim 21, wherein the elastic film is a fully thermoset elastomer.

32. The article of claim 21, wherein the elastic film has a thickness ranging from about 1 to about 25 mils.

33. The article of claim 21, wherein the first adhesive layer is free of discontinuities.

34. The article of claim 21, wherein the second adhesive layer is elastomeric, wherein the second adhesive layer is free of discontinuities, and further comprising: a substrate bonded to the second adhesive layer, the second adhesive layer being positioned between the elastic film and substrate, wherein the substrate is at least one of elastic and elastomeric, and wherein the elastic film has an elasticity the same as or greater than an elasticity of the substrate.

35. The article of claim 21, wherein the first adhesive layer is selected from the group consisting of polyethylene, isobutylene, polyamide, polyvinyl acetate, acrylic, vinyl-acrylic, vinyl, urethane, styrene-butadiene latexes, polyethylene-vinylacetate copolymer, polyethylene-ethylacrylate copolymer, polyester, polyvinyl chloride, polyurethane, polyester, acrylic resin, polyvinyl chloride, thermoplastic acrylic resin, polyethylene, paraffin and rubber derivative.

36. The article of claim 21, wherein the first adhesive layer has a thickness ranging from about 1 to about 10 mils.

37. The article of claim 21, wherein the second adhesive layer is selected from the group consisting of polyethylene, isobutylene, polyamide, polyvinyl acetate, acrylic, vinyl-acrylic, vinyl, urethane, styrene-butadiene latexes, polyethylene-vinylacetate copolymer, polyethylene-ethylacrylate copolymer, polyester, polyvinyl chloride, polyurethane, polyester, acrylic resin, polyvinyl chloride, thermoplastic acrylic resin, polyethylene, paraffin and rubber derivative.

38. The article of claim 21, wherein the second adhesive layer has a thickness ranging from about 1 to about 25 mils.

39. The article of claim 21, wherein one of the following is true:
(i) the second adhesive layer is porous and the first adhesive layer is nonporous;
(ii) the second adhesive layer is nonporous and the first adhesive layer is porous;
(iii) the second adhesive layer is porous and the first adhesive layer is porous; and
(iv) the second adhesive layer is nonporous and the first adhesive layer is nonporous.

40. The article of claim 21, wherein the second adhesive layer is a hot melt polyester web adhesive.

41. An article, comprising: a plurality of flock fibers; an elastic film having first and second sides, wherein the elastic film comprises rubber and/or an elastomeric material and wherein at least one of the following is true: (i) the elastic film has a modulus of elasticity of less than about 11.25 lb/ft and more than about 0.5 lb/ft, (ii) the elastic film has an elongation of at least about 200%, and (iii) the elastic film has a recovery of at least about 75% after being stretched to 100% of the film's length and allowed to retract freely; and a first adhesive layer bonded to the first side of the elastic film and to the plurality of flock fibers.

42. The article of claim 41, further comprising: a second adhesive layer bonded to the second side of the elastic film, wherein the first adhesive layer is continuous, wherein the first adhesive layer is thermoplastic.

43. The article of claim 41, wherein the elastic film is a fully thermoset elastomer.

44. The article of claim 41, wherein the first adhesive layer is free of discontinuities.

45. The article of claim 42, wherein the second thermoplastic adhesive layer is free of discontinuities.

46. The article of claim 42, wherein the first thermoplastic adhesive layer is selected from the group consisting of polyethylene, isobutylene, polyamide, polyvinyl acetate, acrylic, vinyl-acrylic, vinyl, urethane, styrene-butadiene latexes, polyethylene-vinylacetate copolymer, polyethylene-ethylacrylate copolymer, polyester, polyvinyl chloride, polyurethane, polyester, acrylic resin, polyvinyl chloride, thermoplastic acrylic resin, polyethylene, paraffin and rubber derivative.

47. The article of claim 46, wherein the second thermoplastic adhesive layer is selected from the group consisting of polyethylene, isobutylene, polyamide, polyvinyl acetate, acrylic, vinyl-acrylic, vinyl, urethane, styrene-butadiene latexes, polyethylene-vinylacetate copolymer, polyethylene-ethylacrylate copolymer, polyester, polyvinyl chloride, polyurethane, polyester, acrylic resin, polyvinyl chloride, thermoplastic acrylic resin, polyethylene, paraffin and rubber derivative and wherein one of the following is true:
(i) the second thermoplastic adhesive layer is porous and the first thermoplastic adhesive layer is nonporous;
(ii) the second thermoplastic adhesive layer is nonporous and the first thermoplastic adhesive layer is porous;
(iii) the second thermoplastic adhesive layer is porous and the first thermoplastic adhesive layer is porous; and
(iv) the second thermoplastic adhesive layer is nonporous and the first thermoplastic adhesive layer is nonporous.

48. An article manufactured by steps, comprising: (a) contacting flock with a pre-formed and self-supporting first permanent adhesive layer, wherein the first permanent adhesive layer is a thermoplastic adhesive; (b) contacting the first permanent adhesive layer with an elastic film, the flock and first permanent adhesive layer being located on a common side of the elastic film, wherein at least one of the following is true: (i) the elastic film has a modulus of elasticity of less than about 11.25 lb/ft and more than about 0.5 lb/ft, (ii) the elastic film has an elongation of at least about 200%, and (iii) the elastic film has a recovery of at least about 75% after being stretched to 100% of the film's length and allowed to retract freely; and (c) when the first permanent adhesive layer is in contact with the flock and elastic film, embedding the flock into the first permanent adhesive; and (d) contacting the elastic film with a second adhesive layer, wherein the second adhesive layer is thermoplastic and wherein the first and second thermoplastic adhesive layers are located on opposing sides of the elastic film.

49. The article of claim 48, wherein contacting steps (a), (b), and (c) are performed substantially simultaneously.

50. The article of claim 49, wherein each of the first permanent adhesive layer, elastic film, and second permanent adhesive layer are preformed before the contacting steps (a), (b), (c), and (d).

51. The article of claim 49, wherein the flock is adhered to a release adhesive located on a carrier before the contacting step (a) and wherein the first and second thermoplastic adhesive layers are continuous.

52. The article of claim 48, wherein (i) is true.

53. The article of claim 48, wherein (ii) is true.

54. The article of claim 48, wherein (iii) is true.

55. The article of claim 49, wherein the first thermoplastic adhesive layer is selected from the group consisting of polyethylene, butryals, acrylates, aldehydes, polyurethanes, phenolics, alkyds, amino resins, polyesters, epoxides, silicones, and mixtures thereof, wherein the second thermoplastic adhesive layer is selected from the group consisting essentially of polyethylenes, isobutylenes, polyesters, polyurethanes, polyamides, poly(vinyl acetate), and mixtures thereof, and wherein the second thermoplastic adhesive layer is porous and the first thermoplastic adhesive layer is nonporous.

56. The article of claim 48, wherein one of the following is true:
(i) the second thermoplastic adhesive layer is porous and the first thermoplastic adhesive layer is nonporous;
(ii) the second thermoplastic adhesive layer is nonporous and the first thermoplastic adhesive layer is porous;
(iii) the second thermoplastic adhesive layer is porous and the first thermoplastic adhesive layer is porous; and
(iv) the second thermoplastic adhesive layer is nonporous and the first thermoplastic adhesive layer is nonporous.
